(19) United States
(12) Patent Application Publication
(10) Pub. No.: US 2025/0285850 A1
(43) Pub. Date: Sep. 11, 2025

(54) Pseudo MS3 Strategy Employing PTR for Labelled Quantitative Proteomics

(71) Applicant: DH Technologies Development Pte. Ltd., Singapore (SG)

(72) Inventors: Pavel RYUMIN, Toronto (CA); Takashi BABA, Richmond Hill (CA)

(73) Assignee: DH Technologies Development Pte. Ltd., Singapore (SG)

(21) Appl. No.: 18/858,565

(22) PCT Filed: Apr. 21, 2023
(86) PCT No.: PCT/IB2023/054108

§ 371 Date: Oct. 21, 2024

Related U.S. Application Data
(60) Provisional application No. 63/333,891, filed on Apr. 22, 2022.

(51) Int. Cl. H01J 49/00

(52) U.S. Cl. CPC H01J 49/0045

(57) ABSTRACT

In one aspect, a method of performing mass spectrometry is disclosed, which includes selecting a precursor ion having an m/z ratio in a range of interest from among a plurality of ions, identifying a charge state of the selected precursor ion, e.g., based on distribution of mass peaks associated with different isotopes in a mass spectrum. The charge state of the selected precursor ion can be reduced to generate a respective charge-reduced ion at a known m/z ratio. The charge-reduced ion can be subjected to fragmentation to generate a plurality of product ions (which are herein also referred to as fragment ions). A mass analysis of the product ions can then be performed.

### RELATED APPLICATIONS

This application claims the benefit of priority from U.S. Provisional Application No. 63/333,891, filed on Apr. 22, 2022, entitled “Pseudo MS3 Strategy Employing PTR for Labelled Quantitative Proteomics,” the entire contents of which is hereby incorporated by reference.

### TECHNICAL FIELD

The present disclosure is generally directed to methods and systems for performing mass spectrometry, and more particularly, to such methods and systems that can be employed to resolve interferences in mass spectra of tagged peptides.

### BACKGROUND

Mass spectrometry (MS) is an analytical technique for determining the elemental compositions of test substances with both quantitative and qualitative applications. For example, MS can be used to identify unknown compounds, to determine the isotopic composition of elements in a molecule, and to determine the structure of a particular compound by observing its fragmentation, as well as to quantify the amount of a particular compound in a sample.

Mass spectrometry has become an important tool in labeled quantitative proteomics, for example, for single cell proteomics applications. One of the challenges associated with the use of conventional proteomics mass analysis techniques is the possibility that different precursor ions be co-isolated, thus leading to mass signal interference. Conventionally, MS3 tandem mass spectrometry has been used to deal with such a problem. However, MS3 tandem mass spectrometric analysis suffers from poor sensitivity as a result of a large number of fragments that are typically generated in a conventional MS2 spectrum of certain analytes, such as a peptide. One conventional approach for alleviating this problem is the isolation of MS2 fragments using synchronous precursor selection (SPS). One disadvantage of such an approach, which is known as SPS-MS3, is that it requires a dedicated MS2 scan in order to confirm the m/z of MS2 fragments, which adversely affects the throughput of this approach.

### SUMMARY

In one aspect, a method of performing mass spectrometry is disclosed, which includes selecting a precursor ion having an m/z ratio in a range of interest from among a plurality of ions, and identifying a charge state of the selected precursor ion. The charge state of the selected precursor ion can be reduced to generate a respective charge-reduced ion at a known m/z ratio. The charge-reduced ion can be subjected to fragmentation to generate a plurality of product ions (which are herein also referred to as “fragment ions,” or “fragment product ions”). A mass analysis of the fragment ions can then be performed.

In a related aspect, a method of performing mass spectrometry is disclosed, which includes ionizing a sample containing a plurality of peptides tagged with one or more labeling reagents to generate a plurality of tagged peptide ions, selecting precursor peptide ions having an m/z ratio in a target range from among the tagged peptide ions, identifying a charge state of the precursor peptide ions, reducing the charge state of the precursor peptide ions to generate respective charge-reduced ions at a known m/z ratio, subjecting the charge-reduced ions to fragmentation to generate a plurality of fragment ions, and performing a mass analysis of the fragment ions.

A sample under analysis can contain different types of peptides. In some such cases, the selection of the precursor peptide ions can result in the co-isolation of different precursor ions. The reduction of the charge state of the precursor ions can result in increasing the separation of different precursor ions in the m/z space, thereby facilitating the mass analysis of such precursor ions.

In a related aspect, a mass spectrometer is disclosed, which includes an ion source that is configured to receive a sample and ionize at least a portion of the sample to generate a plurality of analyte ions, a mass filter positioned downstream of the ion source for receiving at least a portion of the analyte ions and being configured to select precursor ions having an m/z ratio in a target range from among said received analyte ions, a charge-reduction device positioned downstream of the mass filter and configured to receive the precursor ions and to cause a reduction in a charge state of at least a portion of the received precursor ions to generate a plurality of respective charge reduced ions at a known m/z ratio. In some embodiments, the charge-reduced ions are received by a downstream mass filter that can be configured to select charge-reduced ions having an m/z ratio in a target range or at a target value for subsequent fragmentation and mass analysis of the fragment ions.

In other embodiments, the charge reduced ions can be received by an ion trap. In some such embodiments, the ion trap can be used for further separation of the ions in the m/z space. For example, an AC resonant excitation can be used for mass selective release of the unwanted charge reduced ions from the ion trap, so that the remaining ions can be received by a downstream fragmentation device. In another embodiment, an AC excitation can be used to cause selective dissociation of charge reduced ions having m/z ratios within a target m/z range.

In some embodiments, the mass spectrometer can include a dissociation device, e.g., a collision cell, that can be employed to cause fragmentation of the released charge-reduced ions, thereby generating a plurality of fragment ions. A mass analyzer positioned downstream of the dissociation device can receive the fragment ions and generate mass detection signals indicative of the mass-to-charge ratios of the product ions. A mass analysis module in communication with the mass analyzer can receive the mass detection signals and can process the mass detection signals to generate a mass spectrum of the fragment ions.

The charge reduction device can be a proton transfer reaction (PTR) cell having a first inlet for receiving the selected precursor ions, a second inlet for receiving a reagent for reacting with the precursor ions to cause a reduction in their charge state, and a first outlet through which the charge-reduced ions can exit the PTR cell.

Further understanding of various aspects of the present teachings can be obtained by reference to the following detailed description in conjunction with the associated drawings, which are described briefly below.

### BRIEF DESCRIPTION OF THE DRAWINGS

FIGS. 1A and 1B are flow charts depicting various steps in examples of implementations of a method according to the present teachings for performing mass spectrometry,

FIG. 2A is a schematic view of a mass spectrometer according to an embodiment of the present teachings.

FIG. 2B is a partial schematic view of a mass spectrometer according to an embodiment in which charge reduced ions generated in a PTR device are introduced into a downstream ion trap and selected from the ion trap by removing all ions having m/z ratios within a predefined m/z range (e.g., via mass selective ejection), which are consequently introduced into a dissociation device,

FIG. 2C schematically depicts the reduction of the charge state of two precursor ions having 3+ and 2+ charge states by one charge unit and the selective ejection of the charge reduced ion having a +1 charge state (i.e., the charge reduced ion generated via the charge reduction of the ion with 2+ charge state) from the ion trap in FIG. 2B, via application of resonant excitation with a notch for charge reduced product from 3+ precursor.

FIGS. 2E and 2D schematically depict reducing the charge state of two precursor ions having charge states +3 and +2, respectively, by one charge unit and selectively rejecting the resultant charge reduced ion having +2 charge state from the PTR device for introduction into an ion trap,

FIG. 3 schematically depicts a mass spectrometer according to an embodiment in which an ECD device is used for causing fragmentation of charge reduced ions generated in a PTR device, and

FIG. 4 is an example of an implementation of a controller and/or a mass analysis module suitable for use in embodiments of the present teachings.

### DETAILED DESCRIPTION

It will be appreciated that for clarity, the following discussion will explicate various aspects of embodiments of the present disclosure, while omitting certain specific details wherever convenient or appropriate to do so. For example, discussion of like or analogous features in alternative embodiments may be somewhat abbreviated. Well-known ideas or concepts may also for brevity not be discussed at any great detail. One of ordinary skill will recognize that some embodiments of the present disclosure may not require certain of the specifically described details in every implementation, which are set forth herein only to provide a thorough understanding of the embodiments. Similarly, it will be apparent that the described embodiments may be susceptible to alteration or variation according to common general knowledge without departing from the scope of the disclosure. The following detailed description of embodiments is not to be regarded as limiting the scope of the applicant's teachings in any manner.

As used herein, the terms “about” and, “substantially, and “substantially equal” refer to variations in a numerical quantity and/or a complete state or condition that can occur, for example, through measuring or handling procedures in the real world; through inadvertent error in these procedures; through differences in the manufacture, source, or purity of compositions or reagents; and the like. Typically, the terms “about” and “substantially” as used herein means 10% greater or lesser than the value or range of values stated or the complete condition or state. For instance, a concentration value of about 30% or substantially equal to 30% can mean a concentration between 27% and 33%. The terms also refer to variations that would be recognized by one skilled in the art as being equivalent so long as such variations do not encompass known values practiced by the prior art.

As used herein the term “and/or” includes any and all combinations of one or more of the associated listed items and may be abbreviated as “/”.

The present disclosure relates generally to methods and systems for reducing the charge state of an analyte, e.g., a peptide, during mass spectrometric analysis of that analyte. As discussed in more detail below, in many embodiments, such charge reduction of an analyte under mass analysis can reduce, and preferably eliminate, interferences in MS and MS/MS spectra. For example, when the charge reduction is performed prior to mass selection of a precursor ion, it can improve the isolation of the precursor analyte ions (e.g., a precursor peptide ion) and eliminate chimeric spectra (mixed MS/MS). This is particularly advantageous in labelled peptide quantitative mass analysis. For example, in such mass analysis, in absence of charge reduction, the convolution of precursor ions having +2 and +3 charge states may lead to inaccurate quantitative results. In some embodiments, by reducing the charge state of the precursor ions, the isolation region for selecting the precursor ions can be easily computed and automated without performing a mass analysis step. This can in turn lead to a significant improvement in the duty cycle associated with mass analysis as compared to traditional approaches for enhancing the duty cycle. In embodiments, the methods of the present disclosure can be viewed as performing MS3 analysis without MS/MS spectral collection.

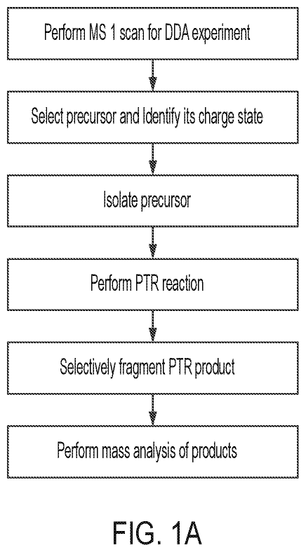

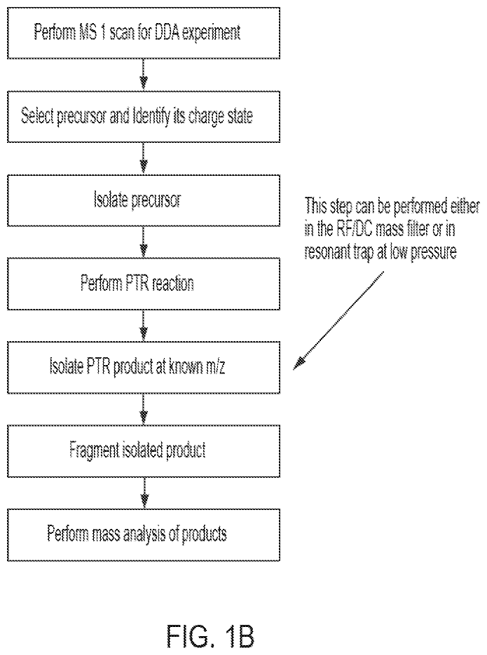

FIG. 1A is a flow chart depicting various steps in a method according to an embodiment of the present teachings for performing mass spectrometry, which includes selecting a precursor ion having an m/z ratio of interest from among a plurality of ions and identifying a charge state of the selected precursor ion.

By way of example, such a selection of a precursor ion with the desired m/z ratio can be achieved using a mass filter operating in a data dependent acquisition (DDA) mode. By way of example, as discussed in more detail below, in some such embodiments, the mass filter can be implemented by utilizing a plurality of rods that are arranged in a multipole configuration, e.g., a quadrupole configuration, and to which RF and resolving DC voltages can be applied to provide radial trapping of the ions and to allow the selection of precursor ions having an m/z ratio of interest for further processing.

In Data Dependent Acquisition (DDA), an MS spectrum is acquired and all of the mass peaks in the acquired MS spectrum are processed and one or more mass peaks associated with selected precursor ions are chosen for further analysis based on predefined criteria, such as their intensity, charge state, m/z range, etc. Peaks selected for subsequent analysis are subjected to MS/MS or MS2 acquisition, wherein corresponding peaks are isolated (e.g., using quadrupole filters) and subsequently fragmented using one of various known fragmentation techniques, e.g., CID, ECD, UVPD, IRMPD, etc.

Since the selection of the precursor ion in an DDA mass analysis requires the acquisition of an MS spectrum, the same MS spectrum can be used to determine the charge state of the precursor ion(s) of interest, via application of various peak finding algorithms known in the art. For example, the relative distance between isotopic peaks can be used in a manner known in the art to determine the charge state of the precursor ions.

The precursor ions are then subjected to a charge reduction reaction to reduce their charge state, e.g., by one charge unit. In this embodiment, the precursor ions are subjected to a proton transfer reaction (PTR) to reduce their charge state, e.g., by one charge unit, to generate a plurality of reduced charge ions.

By way of example, the precursor ions as well as a plurality of reagent ions that can react with the precursor ions to reduce their charge state can be introduced into a reaction cell (e.g., a PTR device as discussed below), in which the precursor ions can be trapped and thus be allowed to interact with the reagent ions such that the reaction would lead to a reduction in the charge state of the precursor ions. An example of a reagent for reducing the charge state of positively charged analyte ions that can be utilized in the practice of the present teachings is perfluoroperhydrophenanthrene. In some embodiments, positively charged xenon ions can be employed for reducing the charge state of a negatively charged ion. In other embodiments, a strong neutral base gas can be used, producing an ion/molecule reaction that reduces the charge state of the ions.

The charge-reduced ions can then be transferred for mass spectrometry analysis, wherein those ions are isolated and subsequently fragmented. Multiple methods are known for achieving this goal, e.g., the reacted ions can be directed to an RF+DC quadrupole set for filtering out anything but charge reduced ions of interest and further subjected to a CID process in the collision cell. Alternatively, ions can be isolated using resonant excitation in 3D trap, linear ion trap or Qtrap devices or other devices suitable for mass selection via resonant excitation and further those ions can be subjected to CID fragmentation either in the same ion trap or in the collision cell. Finally, in some embodiments, only a selected m/z range can be resonantly excited in order to induce fragmentation while remaining reacted ions from different species are kept unfragmented. Such fragmentation can be also performed in 3D trap, LIT or Qtrap device at elevated pressure, wherein excited ions are colliding with the bath gas instead of leaving the trap. In some embodiments the PTR device can be setup in said 3D trap, LIT or Qtrap. It is known in the art that other parameters such as ion excitation amplitude and duration, when selected in accordance with the known pressure regime can facilitate either ion fragmentation or ion isolation.

In some embodiments, the extracted charge-reduced ions can be optionally trapped in an ion trap (e.g., an ion trap implemented using a plurality of rods arranged in a multipole configuration with terminating end caps or lenses to which appropriate RF and DC voltages are applied).

The charge-reduced ions can then be released from the ion trap to be received by a downstream collision cell in which the released charge-reduced ions undergo collisions with a background gas (e.g., N₂), which can cause fragmentation of the charge-reduced ions to generate a plurality of fragment ions (herein also referred to as “product ions” or “fragment ions”).

A mass analysis of the product ions can be performed to generate a mass spectrum thereof.

As the m/z ratio of the selected precursor ions was known prior to the charge reduction reaction and the change in the charge state is also known, the m/z ratios of the charge reduced ions will be known as well. This facilitates arranging for their extraction from a cell in which they underwent the charge reduction reaction. For example, as discussed in more detail below, a combined DC/AC voltage barrier can be utilized to retain the unreacted precursor ions in a PTR cell while allowing the charge-reduced ions to exit the cell and be received by an ion storage device. The stored ions can then be released from the ion storage device to be received by an ion trap and then transferred (e.g., via mass selective approaches) to a collision cell for fragmentation, e.g., via collision of the charge-reduced ions with a background gas, such as nitrogen.

By way of further illustration and with reference to the flow charts of FIGS. 1A and 1B, a method for performing mass spectrometry in according with the present teachings can be implemented by performing an MS1 scan associated with a DDA mass analysis and the precursor ions of interest (i.e., the precursor ions having an m/z ratio within a desired range and/or at a specific m/z value) can be selected and their charge state can be identified, e.g., via analysis of isotopic mass peaks. The precursor ions can be isolated, e.g., in a PTR cell, and can be subjected to a charge reduction reaction to generate a plurality of charge reduced ions (herein also referred to as PTR product ions). The PTR product ions can be selectively fragmented and the ion fragments can be mass analyzed.

With particular reference to the flow chart of FIG. 1B, the PTR product ions at known m/z ratios can be isolated and the isolated ions can be fragmented to generate a plurality of fragment ions, which will be mass analyzed. The isolation of the PTR product ions having known m/z ratios can be performed, e.g., in an RF/DC mass filter or in a resonant ion trap maintained at a low pressure, e.g., a pressure in a range of below 1e-4 Torr.

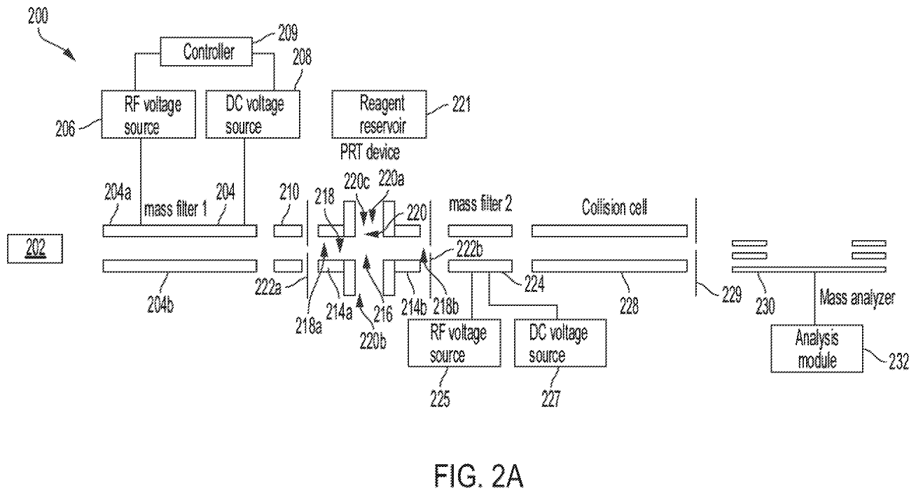

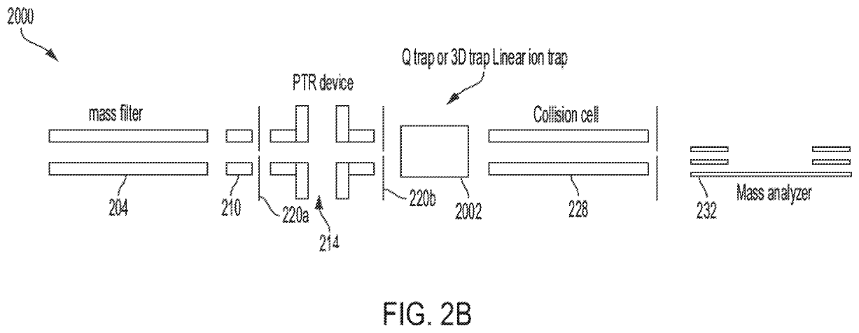

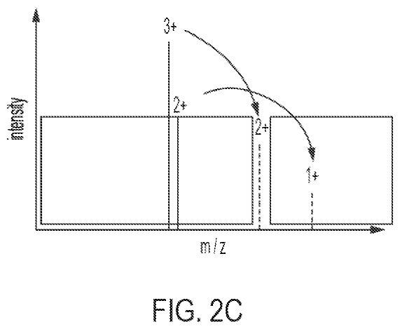

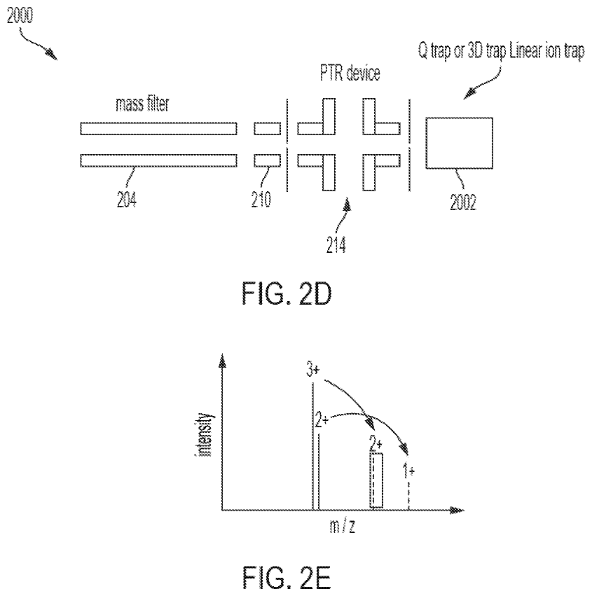

FIG. 2A schematically depicts a mass spectrometer 200 according to an embodiment of the present teachings, which includes an ion source 202 that can receive a sample for which mass analysis is desired and can ionize at least one analyte in the sample to generate a plurality of ions. A mass filter 204 receives the ions and selects ions having a desired m/z ratio. In this embodiment, the mass filter 204 includes four rods (two of which 204a/204b are visible in the figure) that are arranged in a quadrupole configuration. An RF voltage source 206 and a DC voltage source 208 operating under the control of a controller 209 can apply RF and DC voltages to the rods to provide radial confinement of the ions and further allow passage of the ions having a desired m/z ratio through the mass filter while other ions experience unstable trajectories and hence cannot pass through the filter (e.g., they strike the rods).

The mass spectrometer 200 further includes a PTR cell 214 (herein also referred to as PTR device) that is in the form of a branched RF ion trap, which can receive the analyte ions and trap the received ions so that they can interact with a plurality of reagents ions for reducing the charge state of the trapped analyte ions. In this embodiment, the PTR cell 214 is a branched RF ion trap that includes two sets of L-shaped quadrupole rods 214a/214b (only two rods of each set are visible in the figure) that are axially separated from one another to provide an ion trapping region 216 therebetween. Further, the two sets of the quadrupole rods are arranged relative to one another so as to provide a longitudinal passage 218 (herein also referred to as a longitudinal ion channel 218) and a transverse passage 220 (herein also referred to as a transverse ion channel 220). The longitudinal passage includes an inlet 218a through which the analyte ions can enter the PTR cell and an outlet 218b through which the charge reduced ions can exit the PTR cell.

The precursor ions exiting the mass filter 204 are focused via an RF lens (e.g., a Brubaker lens) 210 and through the opening provided in the inlet gate electrode 222a into the PTR cell 220 and undergo a charge reduction reaction with the reagent ions, thereby generating a plurality of charge reduced ions.

Further, the transverse channel 220 includes an inlet 220a through which a plurality of reagent ions can be received from a PTR reagent source 221 (i.e., a source that can generate and/or store a charge-reducing reagent suitable for reacting with the analyte ions to reduce their charge state). The reagent ions can travel through a passageway 220c provided by a transverse arm of the PTR cell to reach the ion trapping region 216. The analyte ions interact with the reagent ions in the ion trapping region to cause a reduction in their electric charge state, e.g., by one charge unit.

For mutual trapping of positive analyte ions and negative reagent ions or vice versa an AC barrier potential can be created at each inlet and outlet of the described PTR device. Such barrier can be arranged, for example, by applying AC voltages to each of the cap electrodes and each interquad lens or in some other embodiments it can be applied to quadrupole rods forming the trap. Such an AC barrier potential will establish the barrier for both negative and positive ions and can facilitate their reaction in the trap. Preferably said reaction device is filled with a bath gas, e.g., N₂ at pressures of 1-10 mTorr to facilitate ion trapping and ion reaction.

The charge reduced ions exiting the PTR cell are received by a downstream ion filter 224. In this embodiment, the ion filter 224 is a quadrupole ion guide having four rods (two of which 226a and 226b are visible in the figure) that are arranged in a quadrupole configuration. The DC and RF voltage sources 208 and 206 (or other RF and/or DC voltage sources) can apply RF and DC voltages to mass select ions of interest. Such RF/DC quadrupole is preferably operated at low pressure of less than 1e-4 Torr.

The mass selected charge reduced ions can then be received by a downstream collision cell 228 to undergo collisions with a background gas (e.g., N₂), which can cause fragmentation of at least a portion of the charge-reduced ions, thereby generating a plurality of product ions. In some embodiments in which mass analysis of labelled peptides is performed, collision induced dissociation (CID) of the charge-reduced ions can cause facile liberation of the reporter ion.

The fragment ions can pass through the collision cell and can be received by a downstream mass analyzer 230, which is configured to generate mass spectral data. A variety of different mass analyzers can be employed in the practice of the present teachings. By way of example, the mass analyzer 230 can be a time-of-flight (Tof) mass analyzer, a quadrupole mass analyzer, and FT-MS, such as Orbitrap among others.

The mass spectrometer 200 further includes an analysis module 232 that is in communication with the mass analyzer 230 to receive the mass spectral data generated by the mass analyzer and to process the mass spectral data to generate a mass spectrum of the fragment ions. As discussed in more detail below, the analysis module 232 can be implemented in hardware, firmware and/or software using techniques known in the art and as informed by the present teachings.

FIG. 2B schematically depicts a mass spectrometer 2000 according to another embodiment of the present teachings in which a PTR device is employed to reduce the charge state of a plurality of precursor ions. The mass spectrometer 2000 includes similar components as those described above in connection with mass spectrometer 200, which function in a similar fashion, except that the second mass filter positioned downstream of the PTR device to receive the charge reduced ions is replaced by a resonant ion trap 2002, which receives the charge-reduced ions from the PTR device and traps those ions and performs ion isolation by mass selective ejection of ions outside a predefined m/z range. In other words, the ions of interest are retained (isolated) in the ion trap and unwanted ions are released. A variety of ion traps, such as a Q trap, or a 3D trap or a linear ion trap, among others, can be employed. Following the m/z isolation step the remaining ions can be transferred to collision cell.

Alternatively the charge-reduced ions of interest can be resonantly ejected from the ion trap, e.g., via application of an AC excitation voltage at a frequency that matches the secular oscillation frequency of the desired charge-reduced ions, to be received by the collision cell in which the charge-reduced ions can undergo fragmentation to generate a plurality of fragment ions, which are in turn received by a downstream mass analyzer to be analyzed in a manner discussed above.

By way of illustration and with reference to FIGS. 2B and 2C, two precursor ions having 3+ and 2+ charge states can be received by the PTR device 214 in which they undergo charge reduction to generate 2+ and 1+ charge-reduced ions.

The charge-reduced ions are received by the ion trap 2002. In this example, the charge-reduced ions having a 1+ charge state can be resonantly ejected from the ion trap (in this example, the ions with m/z ratios associated with the square in which the +1 charged ion is depicted are those that are excited for rejection from the trap) and can be introduced to collision cell 228 in which they will undergo collisional fragmentation to generate a plurality of product ions, which are in turn received and mass analyzed by the downstream mass analyzer 232. Such mass selective ion ejection preferably can be performed at low pressure of <5e-5 Torr or alternatively by appropriately adjusting excitation voltage and duration in a manner known in the art.

As noted above, charge-reduced ions within an ion trap can be selectively fragmented by maintaining the pressure in the ion trap within a suitable range as well as excitation amplitude and dueration and causing selective excitation, e.g., via application of an AC voltage, of those charge-reduced ions having m/z ratios within a target range so as to cause a sufficient increase in their kinetic energy that would lead to their fragmentation in collisions with the molecules of a background gas present in the ion trap.

By way of example, with reference to FIGS. 2D and 2E, the charge-reduced ions having a 2+ charge state can alternatively be resonantly excited, e.g., via resonant AC excitation having a frequency that matches the secular oscillation frequency of those ions, in ion trap 2002 pressurized to a pressure in a range of about 1 to about 10 mTorr so as to cause their fragmentation following collisions with the molecules of the bath gas 228. The remaining ions (1+) in this case are unfragmented and therefore not contributing to the product ions.

The use of a PTR device for reducing the charge state of precursor ions selected via an MS1 stage of a tandem mass analysis of a compound provides a number of advantages. As noted above, in a conventional labelled proteomics analysis, co-isolation of different precursor ions can occur, which can result in signal interference. Conventionally, MS3 mass analysis techniques are employed to deal with such a problem, by applying an MS2 mass analysis to fragment ions to select fragment ions of interest. However, a large number of fragment ions are typically generated in a conventional peptide MS2 spectrum, which can lead to poor sensitivity.

One advantage of the present teachings is that they allow eliminating the step of MS2 spectrum acquisition. In particular, since the charge state of the precursor ion of interest can be inferred from the MS1 mass analysis, the m/z ratio of the charge reduced ions is well defined, thus eliminating an additional MS2 mass analysis step that would otherwise be required to select product ions of interest for mass analysis.

In some embodiments, electron transfer dissociation (ETD), such as EDD (electron detachment dissociation), or electron capture dissociation (ECD) can be employed, rather than CID, for generating fragment ions.

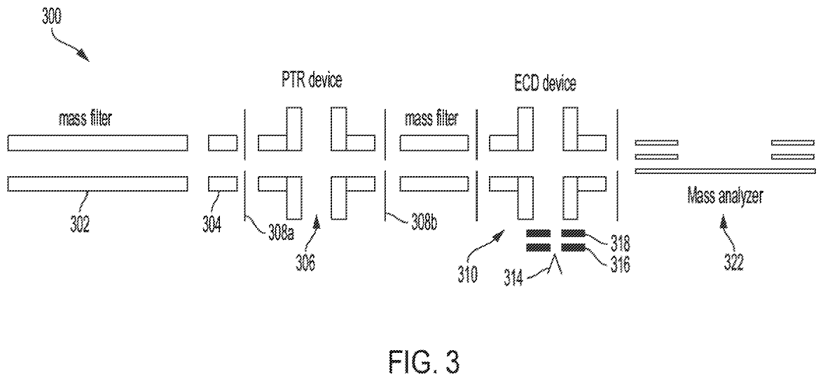

FIG. 3 schematically depicts an embodiment of a mass spectrometer 300 in which ETD or ECD, rather than CID, is employed for generating fragment ions of a selected precursor ion and generating a mass spectrum of those fragment ions.

Similar to the previous embodiments, the mass spectrometer 300 includes a mass filter 302 that can receive a plurality of ions from an upstream ion source (not shown) and select ions having an m/z ratio of interest or an m/z ratio within a target range of interest as a plurality of precursor ions that are focused, via an RF lens 304, into a PTR device 306.

Similar to the previous embodiments, mutual trapping of positive analyte ions and negative reagent ions or vice versa can be achieved in the PTR device via application of AC barrier potentials to inlet and outlet electrodes 308a/308b in a manner known in the art as informed by the present teachings. The analyte ions received in the PTR device can undergo charge-reduction reactions with a charge-reducing reagent, and the charge-reduced ions can be received by a downstream electron capture dissociated (ECD) device 310. The ECD device 310 is implemented as a branched RF ion trap having an inlet 310a through which the charge-reduced ions can enter the trap and an outlet 310b through which product ions generated via ECD fragmentation of the charge-reduced ions can exit to be received by a downstream mass analyzer 312.

A filament 314 can generate electrons that are accelerated via a DC potential difference established between the filament and a gate electrode 316 to enter the ECD device via a transverse passage thereof for interaction with the charge-reduced ions. A pole electrode 318 can be utilized to inhibit e.g., via establishment of a potential difference between the pole electrode and the rods of the ECD device, leakage of the charge-reduced ions from the ECD device.

Further, in this embodiment, a plurality of endcap electrodes 320a/320b/320c/320d positioned in proximity of the inlets and outlets of the longitudinal and transverse channels of the ECD device can be utilized to trap the charge-reduced ions in the ECD device, e.g., via application of appropriate AC and/or DC voltages to the endcap electrodes.

The product ions can be released from the ECD device to be received by a downstream mass analyzer 322, which is configured to generate mass spectral data associated with those product ions.

A controller and/or a mass analysis unit suitable for use in the practice of the present teachings can be implemented using techniques known in the art as informed by the present teachings.

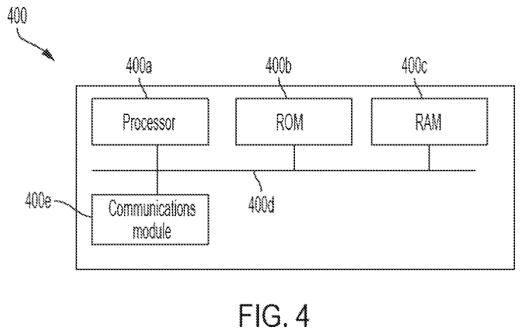

As noted above, a controller and an analysis module suitable for use in the practice of the present teachings, such as the above controller 209 and the analysis module 232 can be implemented in hardware, firmware and/or software in a manner known in the art as informed by the present teachings. By way of example, FIG. 4 schematically depicts an example of such an implementation of the analysis module 232.

FIG. 4 schematically depicts an example of an implementation of such an analysis 400, which includes a processor 400a (e.g., a microprocessor), at least one permanent memory module 400b (e.g., ROM), at least one transient memory module (e.g., RAM) 400c, and a communication bus 400d, among other elements generally known in the art.

The communication bus 400d allows communication between the processor and various other components of the controller. In this example, the controller 400 can further include a communications module 400e that is configured to allow sending and receiving signals.

Instructions for use by the analysis module 400 for analyzing the mass spectral data and generating a mass spectrum of the product ions can be stored in the permanent memory 400b and can be transferred during runtime into the transient memory module 400c for execution. Similarly, the instructions for use by the controller 209, e.g., for controlling the operation of the RF and/or DC voltage sources, can be stored in the permanent memory module 400b and be transferred into the transient memory for execution during runtime.

Those having ordinary skill will appreciate that various changes may be made to the above embodiments without departing from the scope of the invention.

The above detailed description refers to the accompanying drawings. The same or similar reference numbers may have been used in the drawings or in the description to refer to the same or similar parts. Also, similarly named elements may perform similar functions and may be similarly designed, unless specified otherwise. Details are set forth to provide an understanding of the exemplary embodiments. Embodiments, e.g., alternative embodiments, may be practiced without some of these details. In other instances, well known techniques, procedures, and components have not been described in detail to avoid obscuring the described embodiments.

The foregoing description of the embodiments has been presented for purposes of illustration only. It is not exhaustive and does not limit the embodiments to the precise form disclosed. While several exemplary embodiments and features are described, modifications, adaptations, and other implementations may be possible, without departing from the spirit and scope of the embodiments. Accordingly, unless explicitly stated otherwise, the descriptions relate to one or more embodiments and should not be construed to limit the embodiments as a whole. This is true regardless of whether or not the disclosure states that a feature is related to “a,” “the,” “one,” “one or more,” “some,” or “various” embodiments. As used herein, the singular forms “a,” “an,” and “the” may include the plural forms unless the context clearly dictates otherwise. Further, the term “coupled” does not exclude the presence of intermediate elements between the coupled items. Also, stating that a feature may exist indicates that the feature may exist in one or more embodiments

In this disclosure, the terms “include,” “comprise,” “contain,” and “have,” when used after a set or a system, mean an open inclusion and do not exclude addition of other, non-enumerated, members to the set or to the system. Further, unless stated otherwise or deducted otherwise from the context, the conjunction “or,” if used, is not exclusive, but is instead inclusive to mean and/or. Moreover, if these terms are used, a subset of a set may include one or more than one, including all, members of the set.

Further, if used in this disclosure, and unless stated or deducted otherwise, a first variable is an increasing function of a second variable if the first variable does not decrease and instead generally increases when the second variable increases. On the other hand, a first variable is a decreasing function of a second variable if the first variable does not increase and instead generally decreases when the second variable increases. In some embodiment, a first variable may be an increasing or a decreasing function of a second variable if, respectively, the first variable is directly or inversely proportional to the second variable.

The disclosed systems, methods, and apparatus are not limited to any specific aspect or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation.

Modifications and variations are possible in light of the above teachings or may be acquired from practicing the embodiments. For example, the described steps need not be performed in the same sequence discussed or with the same degree of separation. Likewise various steps may be omitted, repeated, combined, or performed in parallel, as necessary, to achieve the same or similar objectives. Similarly, the systems described need not necessarily include all parts described in the embodiments and may also include other parts not described in the embodiments. Accordingly, the embodiments are not limited to the above-described details, but instead are defined by the appended claims in light of their full scope of equivalents. Further, the present disclosure is directed toward all novel and non-obvious features and aspects of the various disclosed embodiments, alone and in various combinations and sub-combinations with one another.

While the present disclosure has been particularly described in conjunction with specific embodiments, many alternatives, modifications, and variations will be apparent in light of the foregoing description. It is therefore contemplated that the appended claims will embrace any such alternatives, modifications, and variations as falling within the true spirit and scope of the present disclosure.

What is claimed is:

1. A method of performing mass spectrometry, comprising:
selecting a precursor ion having an m/z ratio in an m/z range of interest from among a plurality of ions,
identifying a charge state of the selected precursor ion,
reducing the charge state of the selected precursor ion to generate a respective charge-reduced ion at a known m/z ratio,
subjecting said charge-reduced ion to fragmentation to generate a plurality of product ions, and
performing a mass analysis of the product ions.

2. The method of claim 1, wherein the step of reducing the charge state of the selected precursor ion comprises subjecting said selected precursor ion to a proton transfer reaction (PTR).

3. The method of claim 1, wherein said precursor ion comprises a peptide ion and, optionally, said peptide ion carries a labeling reagent as a tag.

4. (canceled)

5. The method of claim 1, wherein the step of reducing the charge state of the selected precursor ion comprises reducing the charge state by one charge unit.

6. The method of claim 1, further comprising trapping said charge reduced ion in an ion trap prior to subjecting said charge reduced ion to fragmentation.

7. The method of claim 6, wherein said fragmentation of the charge reduced ion is achieved in said ion trap by resonantly exciting said charge reduced ion to increase kinetic energy thereof and thereby facilitating its collision-induced fragmentation.

8. The method of claim 7, wherein said ion trap is maintained at a pressure in a range of about 1 mTorr to about 10 Torr.

9. The method of claim 1, further comprising introducing said charge reduced ion into a fragmentation cell.

10. The method of claim 9, further comprising subjecting said charge reduced ion to fragmentation within said fragmentation cell via collision induced dissociation.

11. The method of claim 1, wherein the charge state of the selected precursor ion is identified based on an isotope profile.

12. The method of claim 11, wherein said isotope profile comprises a ¹³C isotope profile.

13. A method of performing mass spectrometry, comprising:
ionizing a sample containing a plurality of peptides tagged with one or more labeling reagents to generate a plurality of tagged peptide ions,
selecting precursor peptide ions having an m/z ratio in a target range of m/z ratio from among said tagged peptide ions,
identifying a charge state of said precursor peptide ions,
reducing the charge state of said precursor peptide ions to generate respective charge-reduced ions at a known m/z ratio,
subjecting said charge-reduced ions to fragmentation to generate a plurality of product ions, and
performing a mass analysis of the product ions.

14. The method of claim 13, wherein said sample comprises different types of peptides.

15. The method of claim 14, wherein said step of selecting the precursor peptide ions results in co-isolation of different precursor ions.

16. The method of claim 15, wherein said step of reducing the charge state of the precursor ions results in separating said different precursor ions in m/z space.

17. A mass spectrometer, comprising:
an ion source configured to receive a sample and ionize at least a portion of the sample to generate a plurality of analyte ions,
a mass filter positioned downstream of said ion source for receiving at least a portion of said analyte ions and being configured to select precursor ions having an m/z ratio in a target range from among said received analyte ions,
a charge-reduction device positioned downstream of said mass filter and configured to receive said precursor ions and to cause a reduction in a charge state of at least a portion of said received precursor ions to generate a plurality of respective charge reduced ions at a known m/z ratio, and
an ion trap positioned downstream of said charge-reduction device and configured to receive at least a portion of said charged reduced ions.

18. The mass spectrometer of claim 17, further comprising at least one dissociation device positioned downstream of said charge-reduction device for receiving said charge reduced ion and causing dissociation of at least a portion thereof, thereby generating a plurality of product ions.

19. The mass spectrometer of claim 18, further comprising a mass analyzer positioned downstream of said dissociation device to receive at least a portion of said product ions and generate a mass detection signals indicative of mass-to-charge ratios of said product ions.

20. The mass spectrometer of claim 17, wherein said charge reduction device comprises a proton transfer reaction (PTR) cell, and
optionally, said PTR cell comprises a first inlet for receiving said selected precursor ions, a second inlet for receiving a reagent for reacting with said precursor ions to cause said charge reduction, and a first outlet through which the charge-reduced ions can exit the PTR cell.

21. (canceled)

22. The mass spectrometer of claim 18, wherein said dissociation device comprises a collision cell disposed downstream of said ion trap for receiving the charge-reduced ions from said ion trap and causing fragmentation of at least a portion thereof via collisional dissociation to generate a plurality of product ions.
